(19) United States
(12) Patent Application Publication
(10) Pub. No.: US 2015/0117566 A1
(43) Pub. Date: Apr. 30, 2015

(54) METHOD AND SYSTEM FOR MULTI-CHANNEL SIGNAL TRANSMISSION

(71) Applicant: Spreadtrum Communications (Shanghai) Co., Ltd., Shanghai (CN)

(72) Inventors: Zhongping Sun, Shanghai (CN); Feng Tao, Shanghai (CN); Ruzhong Liu, Shanghai (CN); Wulin Shi, Shanghai (CN); Wentao Huang, Shanghai (CN); Guotao Zhao, Shanghai (CN)

(73) Assignee: Spreadtrum Communications (Shanghai) Co., Ltd., Shanghai (CN)

(21) Appl. No.: 14/449,190

(22) Filed: Aug. 1, 2014

(30) Foreign Application Priority Data
Oct. 25, 2013 (CN) 201310513955.2

(51) Int. Cl. H04B 1/04

(52) U.S. Cl. CPC H04B 1/0475; H04B 2001/0416
USPC 375/297

(57) ABSTRACT

The present invention discloses a multi-channel signal transmission system and the transmission method thereof. The system comprises a transmitter, a selection device, a compensation device, and power amplifier modules. The transmitter comprises a Ramp Circuit connected to the transmitter and the power amplifier modules respectively. The selection device is configured between the transmitter and the power amplifier modules. The transmission method comprises: selecting a transmission channel by the transmitter for transmitting the signal, the selection device strobes a transmission route between the transmission channel and the power amplifier modules, and based on different transmission power parameters, the Ramp Circuit transmits different control signals to the power amplifier modules to adjust transmission gain of the power amplifier modules. The present invention has the purpose of improving the integration level of the chip and decreasing the board area and the difficulty of wiring.

### CROSS-REFERENCE TO RELATED APPLICATIONS

The present application claims priority to and the benefit of Chinese Patent Application No. CN 201310513955.2, filed on Oct. 25, 2013, the entire content of which is incorporated herein by reference.

### BACKGROUND OF THE INVENTION

1. Field of the Invention

The present invention relates to the technical field of mobile communication, more specifically, to a method and system for multi-channel signal transmission.

2. Description of the Related Art

There are various communication systems in the field of mobile communication currently. The TD-SCDMA (Time Division-Synchronous Code Division Multiple Access) and the GSM (Global System For Mobile Communications) are considered as two of the most common communication system. The said GSM which belongs to the second generation of mobile communication technology (2G) predates the emergence of TD-SCDMA, and correspondingly, the TD-SCDMA belongs to the third generation of mobile communication technology (3G).

The foresaid TD-SCDMA and GSM are not the only solution for the current mobile communication technology. HSPA (High Speed Packet Access), HSPA+(HSPA Evolution) and WCDMA (Wideband Code Division Multiple Access) which are derived from TD-SCDMA and the EDGE (Enhanced Data Rate for GSM Evolution), GPRS (General Packet Radio Service) derived from GSM belong to the communication technology as well. And the mobile terminal users would get improved service with the possible emerging technologies such as 4G network and 5G network in the future.

However, diverse communication technology with variety of communication models is required for a few mobile terminal users simultaneously. In order to achieve such a goal, several power amplifiers should be installed in a limited space based on the current technology condition, as a result, the design difficulty of the integrated PCB board is increased, and so are the manufacturing cost and the circuit fabrication requirements.

Chinese patent No. CN101227212A has disclosed a gain compensation system of a single antenna TD-SCDMA transmitting chain circuit, wherein the system adds a feedback channel from power amplifier PA to a simulating down converter on the basis of the traditional TD-SCDMA transmission system, the system feeds back transmitting signals to a baseband through utilizing the transmitting-receiving chain circuit according to the characteristic that the upper and lower chain circuits are not working simultaneously in a TD-SCDMA communication mode; and the system also comprises an automatic gain control module which is arranged in a baseband processing unit. The foresaid technical solution is only suitable for the single transmitting channel, which can not solve the existed problems.

Chinese patent No. CN1475043A has disclosed a nonlinear distortion compensating power amplifier which is provided with a signal transmitting circuit, a gain adjustment circuit, a control circuit, a circuit for measuring the input/output power, and a power amplifier. The foresaid technical solution aims to perform nonlinear compensation to the linear power amplifier, which doses not relate to the coexistence issue between the multiple transmitting channels.

### SUMMARY OF THE INVENTION

Due to the above technical problems, the present invention provides a method and system for multi-channel signal transmission. The specific technical solutions are as follows:

A multi-channel signal transmission system, wherein it comprises:
a transmitter which includes a plurality of transmission channels and transmits signals through the transmission channels;
power amplifier modules which are connected to the transmitter and are used to receive and amplify the signals;
a selection device which is set between the transmitter and the power amplifier modules and selects the transmission channels while transmitting the signals; and
a compensation device whose one end is connected to a plurality of transmission channels respectively and another end is connected to an input end of the power amplifier modules; the compensation device performs a compensation to the transmission power output by the power amplifier modules according to the transmission channels used currently.

Preferably, according to the multi-channel signal transmission system, wherein a plurality of the transmission channels share the same or similar frequency band.

Preferably, according to the multi-channel signal transmission system, wherein the end of the selection device connected to the transmitter is connected to a plurality of transmission channels respectively, another end is connected to the power amplifier modules; when the transmitter transmits the signals through one of the transmission channels, the selection device selects the corresponding transmission channel and switches on the transmission route between the transmission channel and the power amplifier modules.

Preferably, according to the multi-channel signal transmission system, wherein the compensation device comprises:
a selection module whose one end is connected to a plurality of transmission channels respectively and another end is connected to the input end of the power amplifier modules; the selection module selects the transmission channel used currently and transmits a corresponding signal according to the selected transmission channel; and
a compensation module which is set between the selection module and an output end of the power amplifier modules; the compensation module receives the corresponding signal transmitted by the selection module and sends a control command of the compensation transmission gain to the power amplifier modules.

Preferably, according to the multi-channel signal transmission system, wherein the selection module comprises:
a selection component whose one end is connected to a plurality of the transmission channels respectively and another end is connected to the compensation module; the selection component selects the transmission channel currently used and input a corresponding selected signal according to the selected transmission channel.

Preferably, according to the multi-channel signal transmission system, wherein the selected signal is the transmission power parameters when the transmitter transmits signals through the transmission channel.

Preferably, according to the multi-channel signal transmission system, wherein the compensation module comprises a conversion component which is connected to the selection component and converts the transmission power parameters transmitted by the selection component to a control signal matching with the transmission gain adjusting signal of the power amplifier modules; and the changes of the control signal is in a one-to-one correspondence with the different transmission power parameters.

Preferably, according to the multi-channel signal transmission system, wherein the compensation module is a Ramp Circuit which inputs the control signal into the power amplifier modules.

A multi-channel signal transmission method, wherein it adopts the multi-channel signal transmission system, the method comprises the steps as follows:
selecting an transmission channel to transmit signals through the transmitter;
switching on the transmission route between the emission channel selected by the transmission device and the power amplifier modules through the selection device;
performing a compensation to the transmission gain of the power amplifier modules in a preconfigured way based on the transmission channel selected by the transmitter through the compensation device; and
amplifying and outputting the signals based on the transmission gain through the power amplifier modules.

Preferably, according to the multi-channel signal transmission method, wherein the preconfigured way comprises:
the control component controls the selection device to select the corresponding transmission channel based on the transmission channel selected by the transmitter;
the selection component strobes the selected transmission channel and outputs the corresponding transmission power parameters to the conversion component;
the conversion component converses the transmitting power signal to the corresponding control signal, and the corresponding control signal is output to the matching component through the Ramp Circuit; and
the matching component takes the corresponding transmission gain adjusting signal based on the control signal, and the matching component adjusts the transmitting gain of the power amplifier modules based on the transmitting gain adjusting signal.

The advantageous effects of the above technical scheme are those as follows: adding a Ramp Circuit on a power amplifier to control the transmitting gain of the power amplifier modules, which realizes the purpose that one PA is reused by the transmission channels having a same or similar frequency band, improving the integration level of the chip and decreasing the board area and the difficulty of wiring.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 shows a structure diagram of the multi-channel signal transmission system in the embodiment of the present invention.

FIG. 2 shows the flow diagram of the multi-channel signal transmission method in the embodiment of the present invention.

FIG. 3 shows the detailed flow diagram of Step 3 in FIG. 2 in the embodiment of the present invention.

### DETAILED DESCRIPTION

The present invention will be further illustrated in combination with the following figures and embodiments, but it should not be deemed as limitation of the present invention.

To meet the request of the cost control of wireless transmission in different 3GPP protocols, a plurality of transmission channels are needed to be applied to a power amplifier to transmit signals. In the embodiment of the present invention, a Power Amplifier (PA) of EDGE is used as a PA shared by both TD-SCDMA and GSM, and a Ramp Circuit of GSM is used to change the gain power in different transmission channels, which realizes the sharing of PA. Consequently, the power is saved, the integration level of the chip is improved, the board area and the difficulty of the wiring are both decreased.

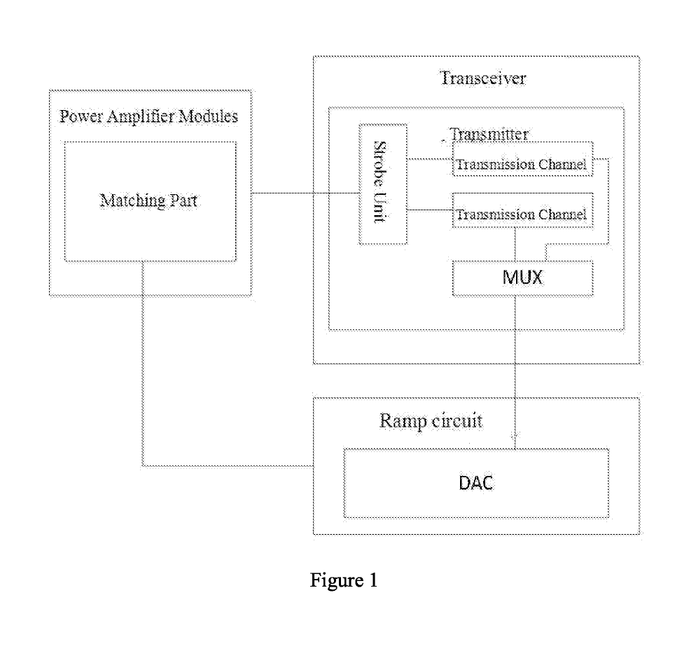

As shown in FIG. 1, in the embodiment of the present invention, a transmission system, which uses a PA to amplify the signals under different communication systems, comprises: a transceiver integrating a transmitter and a receiver. The transmitter comprises a plurality of transmission channels, each of which is using a communication system, the transmitting frequency bands of the communication systems used by the multiple transmission channels are the same or similar. In the embodiment of the present invention, TD-SCDMA and GSM are used to transmit signals, wherein Frequency Band A and Frequency Band F are from 2012 MHz to 2025 MHz and from 1880 MHz to 1920 MHz respectively, the frequency bands of DCS (Digital Cellular Service) and PCS (Personal Communication Service) of GSM are from 1710 MHz to 1785 MHz and from 1850 MHz to 1910 MHz respectively. As the above mentioned frequency bands of TD-SCDMA and GSM are closed to each other, they can be adopted to the signal transmission system in the present invention.

In another embodiment of the present invention, the multi-channel signal transmission system is also applied to the communication system, such as WCDMA (Wideband Code Division Multiple Access) and LTE (Long Term Evolution), which has the same or similar frequency band with the above communication system.

In the embodiment of the present invention, a transmitter which comprises a plurality of transmission channels is connected to a selection device, and the selection device is a multiple pole single throw switch. In the embodiment of the present invention, the selection device is a double pole single throw switch, the check end of which is connected to two transmission channels of the transmitter, while the other end is switched into an input end of the power amplifier modules. The double pole single throw switch strobes a transmission route from the transmission channel to the power amplifier modules, when the transmitter transmits a signal through a transmission channel, which enables the signal to be transmitted to the power amplifier modules and to be amplified.

In the embodiment of the present invention, the power amplifier modules are PAs applied to the EDGE network.

In the embodiment of the present invention, the double pole single throw switch mentioned above is actually located inside the transmitter of the transceiver.

The signal transmission system also comprises a compensation device which includes a selection component. The selection component is a multiple pole single throw switch. In the embodiment of the present invention, the selection component is a double pole single throw switch whose check end is connected to two transmission channels of the transmitter, and whose another end is connected to the compensation device. When a transmission channel is initiated to transmit a signal, the double pole single throw switch in the compensation device strobes the transmission channel and transmits a corresponding selection signal to the compensation device through the transmission channel. In the embodiment of the present invention, the selection signal is an analog signal, furthermore, the content actually contained in the selection signal is a transmission power parameter while a signal is transmitted by the transmitter through the particular transmission channel. Hence, the selection signal is a transmission power parameter.

The compensation device further comprises a conversion component which is connected to the double pole single throw switch in the compensation device. When the double pole single throw switch strobes one of the transmission channels and transmits a corresponding transmission power parameter, the conversion component converts the transmission power parameter to a corresponding control signal and outputs the corresponding control signal into the compensation device. In the embodiment of the present invention, the conversion component is a DAC component (digital analog converter). The control signal matches with the adjusting signal which changes the transmission gain of the power amplifier modules, and the variation of the control signal is in a one-to-one correspondence with the variation of the transmission power parameter.

The selection component (the double pole single throw switch) mentioned above constitutes a selection module (Multiplexer, MUX) in the compensation device. In the embodiment of the present invention, the selection component is actually located inside of the transmitter of the transceiver.

In the embodiment of the present invention, the compensation device comprises a compensation module which comprises the conversion component. In the embodiment of the present invention, the compensation module is a Ramp Circuit in practice. The DAC component mentioned above is comprised in the Ramp Circuit which outputs the control signal conversed by DAC to the power amplifier modules. Consequently, a control signal, which is corresponding to each selection signal, shall be preconfigured in the DAC. The Ramp Circuit adjusts the transmission gain of the power amplifier modules by the way of Ramp compensation.

In the embodiment of the present invention, a matching component may be configured in the power amplifier modules, which is preconfigured with a transmission gain adjusting signal corresponding to a single control signal. When the Ramp Circuit inputs a plurality of control signals to the matching component, the matching component takes the corresponding transmission gain adjusting signal based on each control signal, and then adjusts the transmission gain of the power amplifier modules.

In the embodiment of the present invention, corresponding to the TD-SCDMA communication system, DAC may converse different transmission power parameters received to the corresponding control signals. In the embodiment of the present invention, the control signals may be voltage signals, i.e., the transmission power under the TD-SCDMA communication system is divided into 2-3 different power levels (i.e., power range), and each power level is corresponding to a fixed control signal output, different power levels may be corresponding to the transmission power of transmitting a signal in a communication system evolved under the TD-SCDMA communication system, such as the HSPA or HSPA+and the like. Hence, 2-3 fixed transmission power adjusting signals shall be preconfigured in the matching component. Under the TD-SCDMA communication system, when different transmission power is employed to transmit a signal, gain mode in the power amplifier modules is changed by the Ramp Circuit through outputting 2-3 different fixed control signals. Hence, the power amplifier modules may be the signals output and amplified by 2-3 different transmission gains. Consequently, in the embodiment of the present invention, when transmitting signals under the TD-SCDMA communication system, the signal transmission system has 2-3 transmission gain levels.

In the embodiment of the present invention, corresponding to the GSM communication system, 15 corresponding control signals corresponding to the different transmission powers may be preconfigured in the DAC, that is to say, the transmission power under the GSM communication system is divided into 15 different power levels (i.e., power range), and each power level is corresponding to a control signal. The different power levels may be corresponding to the transmission power of transmitting a signal in a communication system evolved under the GSM communication system, such as GPRS or EDGE and the like. Hence, 15 different transmission gain adjusting signals shall be preconfigured in the matching component. Under the GSM communication system, when different transmission power is employed to transmit a signal, gain mode in the power amplifier modules may be changed by the Ramp Circuit through outputting 15 different control signals, that is to say, 15 different gain levels may be produced in the power amplifier modules and there are 15 different transmission gain correspondingly.

In other embodiment of the present invention, different control signals may be output to the power amplifier modules by the Ramp Circuit through the different transmission power, if WCDMA or LTE communication system is employed to transmit signals.

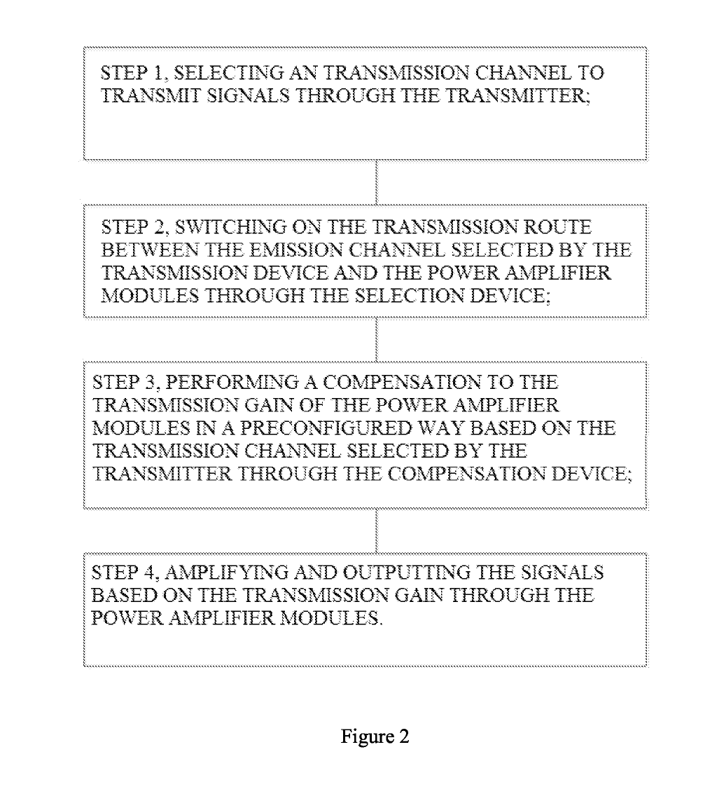

As shown in FIG. 2, in the embodiment of the present invention, a transmission method, which uses the multi-channel signal transmission system to transmit signals, comprises:
Step 1, selecting an transmission channel to transmit signals through the transmitter;
Step 2, switching on the transmission route between the emission channel selected by the transmission device and the power amplifier modules through the selection device;
Step 3, performing a compensation to the transmission gain of the power amplifier modules in a preconfigured way based on the transmission channel selected by the transmitter through the compensation device; and
Step 4, amplifying and outputting the signals based on the transmission gain through the power amplifier modules.

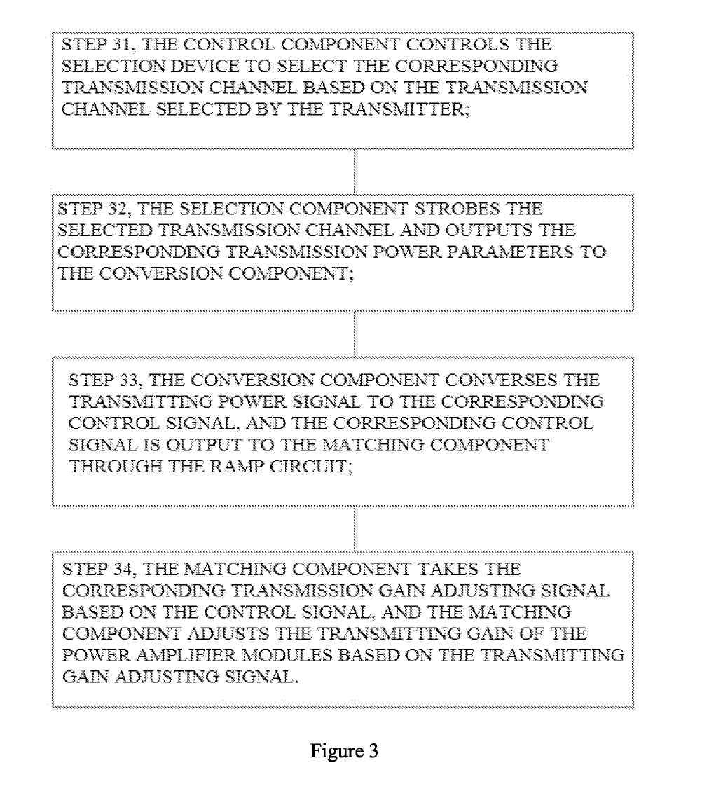

In the embodiment of the present invention, the preconfigured way in Step 3 would be illustrated as shown in FIG. 3:
Step 31, the control component controls the selection device to select the corresponding transmission channel based on the transmission channel selected by the transmitter;
Step 32, the selection component strobes the selected transmission channel and outputs the corresponding transmission power parameters to the conversion component;
Step 33, the conversion component converses the transmitting power signal to the corresponding control signal, and the corresponding control signal is output to the matching component through the Ramp Circuit; and
Step 34, the matching component takes the corresponding transmission gain adjusting signal based on the control signal, and the matching component adjusts the transmitting gain of the power amplifier modules based on the transmitting gain adjusting signal.

Further, in the embodiment of the present invention, the multi-channel signal transmission method is specifically described in below:
the transmitter in the transceiver selects a transmission channel to transmit signals;
the double pole single throw switch between the power amplifier modules and the transmitter strobes the transmission route between the transmission channel used currently and the Ramp Circuit;
the double pole single throw switch in the compensation device strobes the transmission route between the transmission channel used currently and the Ramp Circuit;
the double pole single throw switch transmits the signal including the transmission power parameter which is generated by a transmission channel correspondingly strobed to the DAC;
the DAC converses the signal to a corresponding control signal which is preconfigured, and output the signal to the power amplifier modules through the Ramp Circuit; in the embodiment of the present invention, when the double pole single throw switch strobes TD-SCDMA, DAC outputs one of 2-3 fixed voltage signals based on the power level in which the current transmission power is, that is to say, there are 2-3 gain levels under GSM communication system; and when the double pole single throw switch strobes GSM, data converter generally outputs one of 15 fixed voltage signals based on the transmission power, that is to say, there are 15 gain levels under GSM communication system.

The matching component in the power amplifier modules reads the voltage signal input, and takes the corresponding transmission gain adjusting signal preconfigured; the matching component adjusts the transmission gain of the output end of the power amplifier modules based on the adjusting signal, in order to meet the requirement of the output power transmitted by the current transmission channel.

In the embodiment of the present invention, under the TD-SCDMA communication system, the matching component may switchover between 2-3 different gain levels based on the different control signals input, and then the power amplifier modules may have 2-3 different transmission gains; under the GSM communication system, the matching component may switchover between 15 different gain levels, and then the power amplifier modules may have 15 different transmission gains.

GPIO (General Purpose Input/Output) mode may be adopted in the traditional PA to control its gain level, but such control method is only applied to the PA with a GPIO interface. If the GPIO mode is used to control the PA using the Ramp Circuit, in the GPIO mode, only several fixed voltage values (i.e., control signals) can be output by the system, and the voltage values cannot be adapt to the gain level condition triggered when transmitting a signal under the TD-SCDMA or GSM system. Hence, it is necessary to set a plurality of different voltage dividers on the GIPO interface of the power amplifier modules to attain the required divide value artificially; and, a switch that is set between the GIPO interface and the Ramp Circuit is needed to operate the switch. Hence, in the embodiment of the present invention, a Ramp Circuit is adopted directly to achieve the technical solutions that the PA of the GSM communication system is reused by the TD-SCDMA, which has an outstanding beneficial effect relative to the prior art, and has solved the existing problem in the prior art.

It is obvious for the skilled in the art to make varieties of changes and modifications after reading the above descriptions. Hence, the Claims attached should be regarded as all the changes and modifications which cover the real intention and the range of this invention. Any and all equivalent contents and ranges in the range of the Claims should be regarded belonging to the intention and the range of this invention.

What is claimed is:

1. A multi-channel signal transmission system, wherein it comprises:
a transmitter which includes a plurality of transmission channels and transmits signals through the transmission channels;
power amplifier modules which are connected to the transmitter and are used to receive and amplify the signals;
a selection device which is set between the transmitter and the power amplifier modules and selects the transmission channels while transmitting the signals; and
a compensation device whose one end is connected to a plurality of transmission channels respectively and another end is connected to an input end of the power amplifier modules; the compensation device performs a compensation to the transmission power output by the power amplifier modules according to the transmission channels used currently.

2. The multi-channel signal transmission system as disclosed in claim 1, wherein a plurality of the transmission channels share the same or similar frequency band.

3. The multi-channel signal transmission system as disclosed in claim 1, wherein the end of the selection device connected to the transmitter is connected to a plurality of transmission channels respectively, another end is connected to the power amplifier modules;
when the transmitter transmits the signals through one of the transmission channels, the selection device selects the corresponding transmission channel and switches on the transmission route between the transmission channel and the power amplifier modules.

4. The multi-channel signal transmission system as disclosed in claim 1, wherein the compensation device comprises:
a selection module whose one end is connected to a plurality of transmission channels respectively and another end is connected to the input end of the power amplifier modules; the selection module selects the transmission channel used currently and transmits a corresponding signal according to the selected transmission channel; and
a compensation module which is set between the selection module and an output end of the power amplifier modules; the compensation module receives the corresponding signal transmitted by the selection module and sends a control command of the compensation transmission gain to the power amplifier modules.

5. The multi-channel signal transmission system as disclosed in claim 4, wherein the selection module comprises:
a selection component whose one end is connected to a plurality of the transmission channels respectively and another end is connected to the compensation module; the selection component selects the transmission channel currently used and input a corresponding selected signal according to the selected transmission channel.

6. The multi-channel signal transmission system as disclosed in claim 5, wherein the selected signal is the transmission power parameters when the transmitter transmits signals through the transmission channel.

7. The multi-channel signal transmission system as disclosed in claim 6, wherein the compensation module comprises a conversion component which is connected to the selection component and converts the transmission power parameters transmitted by the selection component to a control signal matching with the transmission gain adjusting signal of the power amplifier modules; and the changes of the control signal is in a one-to-one correspondence with the different transmission power parameters.

8. The multi-channel signal transmission system as disclosed in claim 7, wherein the compensation module is a Ramp Circuit which inputs the control signal into the power amplifier modules.

9. A multi-channel signal transmission method, wherein it adopts the multi-channel signal transmission system comprising a transmitter which includes a plurality of transmission channels and transmits signals through the transmission channels; power amplifier modules which are connected to the transmitter and are used to receive and amplify the signals; a selection device which is set between the transmitter and the power amplifier modules and selects the transmission channels while transmitting the signals; and a compensation device whose one end is connected to a plurality of transmission channels respectively and another end is connected to an input end of the power amplifier modules; the compensation device performs a compensation to the transmission power output by the power amplifier modules according to the transmission channels used currently;
the method comprises the steps as follows,
selecting an transmission channel to transmit signals through the transmitter;
switching on the transmission route between the emission channel selected by the transmission device and the power amplifier modules through the selection device;
performing a compensation to the transmission gain of the power amplifier modules in a preconfigured way based on the transmission channel selected by the transmitter through the compensation device; and
amplifying and outputting the signals based on the transmission gain through the power amplifier modules.

10. The multi-channel signal transmission method as disclosed in claim 9, wherein a plurality of the transmission channels share the same or similar frequency band.

11. The multi-channel signal transmission method as disclosed in claim 9, wherein the end of the selection device connected to the transmitter is connected to a plurality of transmission channels respectively, another end is connected to the power amplifier modules;
when the transmitter transmits the signals through one of the transmission channels, the selection device selects the corresponding transmission channel and switches on the transmission route between the transmission channel and the power amplifier modules.

12. The multi-channel signal transmission method as disclosed in claim 9, wherein the compensation device comprises:
a selection module whose one end is connected to a plurality of transmission channels respectively and another end is connected to the input end of the power amplifier modules; the selection module selects the transmission channel used currently and transmits a corresponding signal according to the selected transmission channel; and
a compensation module which is set between the selection module and an output end of the power amplifier modules; the compensation module receives the corresponding signal transmitted by the selection module and sends a control command of the compensation transmission gain to the power amplifier modules.

13. The multi-channel signal transmission method as disclosed in claim 12, wherein the selection module comprises:
a selection component whose one end is connected to a plurality of the transmission channels respectively and another end is connected to the compensation module; the selection component selects the transmission channel currently used and input a corresponding selected signal according to the selected transmission channel.

14. The multi-channel signal transmission method as disclosed in claim 13, wherein the selected signal is the transmission power parameters when the transmitter transmits signals through the transmission channel.

15. The multi-channel signal transmission method as disclosed in claim 14, wherein the compensation module comprises a conversion component which is connected to the selection component and converts the transmission power parameters transmitted by the selection component to a control signal matching with the transmission gain adjusting signal of the power amplifier modules; and the changes of the control signal is in a one-to-one correspondence with the different transmission power parameters.

16. The multi-channel signal transmission method as disclosed in claim 15, wherein the compensation module is a Ramp Circuit which inputs the control signal into the power amplifier modules.

17. The multi-channel signal transmission method as disclosed in claim 16, wherein the preconfigured way comprises:
the control component controls the selection device to select the corresponding transmission channel based on the transmission channel selected by the transmitter;
the selection component strobes the selected transmission channel and outputs the corresponding transmission power parameters to the conversion component;
the conversion component converses the transmitting power signal to the corresponding control signal, and the corresponding control signal is output to the matching component through the Ramp Circuit; and
the matching component takes the corresponding transmission gain adjusting signal based on the control signal, and the matching component adjusts the transmitting gain of the power amplifier modules based on the transmitting gain adjusting signal.
